(19) United States
(12) Patent Application Publication
(10) Pub. No.: US 2012/0072309 A1
(43) Pub. Date: Mar. 22, 2012

(54) METHOD FOR SECURE TRANSACTIONS

(75) Inventors: Stefan Hultberg, Stockholm (SE); Magnus Westling, Stockholm (SE)

(73) Assignee: ACCUMULATE AB, Stockholm (SE)

(21) Appl. No.: 13/321,735

(22) PCT Filed: Jun. 4, 2010
(86) PCT No.: PCT/SE2010/050613

§ 371 Date: Dec. 6, 2011

(30) Foreign Application Priority Data
Jun. 4, 2009 (SE) 0950408-5

(51) Int. Cl. G06Q 30/06

(52) U.S. Cl. 705/26.41

(57) ABSTRACT

The present invention relates to a method for a secure transaction, wherein a buying part utilizes a portable radio communication device (10), wherein the secure transaction preferably is performed by mobile payment through NFC, and otherwise by use of a predefined identity on a predefined transaction server.

### FIELD OF INVENTION

The present invention relates generally to transactions, and particularly to secure transactions utilizing a portable radio communication device, such as a mobile phone, personal digital assistant, portable computer or similar device.

### BACKGROUND

It is today common with transactions initiated and performed via e.g. Internet. Further, with mobile phones or similar devices it is today possible to perform transactions and related actions through data communication via wireless communication. This provides for a very neat way of performing secure transactions, by always having an electronic authentication device at hand, which could be used as a secure wallet/bank solution. However, this also provides for a variety of ways to manipulate the transaction systems in order to fraud one or both of the parts in a transaction.

An increasingly utilized method for performing transactions through a mobile phone is a so called mobile payment through Radio-Frequency Identification (RFID) or Near Field Communication (NFC). A problem with this solution is however that it is costly to add required functionality to a mobile phone, and the mobile phone manufacturer are thus reluctant to add this functionality in mobile phones without a demand for such a function. Also, it is costly to add NFC functionality at a merchant store in addition to existing payment possibilities, which is required until enough mobile phones support NFC. Neither the mobile phone industry nor the merchants want to take the initial investment to provide this payment alternative for mobile phone users.

### SUMMARY OF THE INVENTION

An object of the present invention is thus to provide secure transactions for portable radio communication devices, which decrease the above mentioned problems.

This object, among others, is according to the present invention attained by a method as defined by the appended claims.

By providing a method for a secure transaction, wherein a buying part of the secure transaction utilizes a portable radio communication device, comprising the steps of:

when a selling part of the secure transaction comprises NFC means and the buying part of the secure transaction comprises NFC means the secure transaction is performed by mobile payment through NFC;

when a selling part of the secure transaction comprises NFC means and the buying part of the secure transaction does not comprise NFC means mobile payment through NFC is emulated by the buying part and the secure transaction is performed by mobile payment through NFC with verification of the buying part; and

otherwise the secure transaction between a selling part and the buying part is performed by mobile payment through a predefined identity on a transaction server,

the most convenient mobile payment is used, at the same time providing a secure transaction for all alternatives.

The predefined identity on a transaction server preferably comprises the steps of:

initiating, by wireless encrypted communication, the portable radio communication device on a predefined transaction server, which portable radio communication device thereby is put in an active transaction state as the buying part on the transaction server, wherein a user transaction software in the portable radio communication device has been installed through an authenticated service provider and a user is securely identified and tied to the installation;

initiating, by the predefined identity, the secure transaction between the buying part, utilizing the user transaction software in the portable radio communication device, and the selling part, utilizing a service provider software;

initiating the selling part on the predefined transaction server, which selling part thereby is put in an active transaction state on the transaction server;

sending information of the secure transaction connected to the predefined identity from the selling part to the predefined transaction server;

identifying the buying part and the selling part on the transaction server by the predefined identity and checking that the buying part and the selling part are in the active transaction state on the transaction server; and

finalizing the secure transaction connected to the predefined identity based on the information of the secure transaction and the predefined identity.

For improved security the method preferably comprises the steps of:

sending, by wireless encrypted communication, the information of the secure transaction connected to the predefined identity from the predefined transaction server to the buying part;

verifying the secure transaction connected to the predefined identity at the buying part by a user verification; and

sending, by wireless encrypted communication, the verification connected to the predefined identity from the buying part to the transaction server.

The verification is preferably performed by entering a personal identification number in the portable radio communication device.

By preferably providing a method for secure transactions wherein both parts in a transaction are connected to a predefined transaction server and independently approves the transaction a secure transaction is achieved.

Preferably, the predefined identity is kept unique only during a specific transaction, whereby the necessary amount of predefined identities can be kept very low at the transaction server, being limiting only for handling parallel transactions at the transaction server.

The verification is preferably performed by entering a personal identification number (PIN) in the portable radio communication device, which PIN is selected during installation of user transaction software.

Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 schematically shows the steps of a method for secure transactions according to an embodiment of the present invention.

FIG. 2 schematically shows the steps of a method for a predefined identity at a transaction server.

FIG. 3 schematically shows communication between transaction parts according to an embodiment of the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

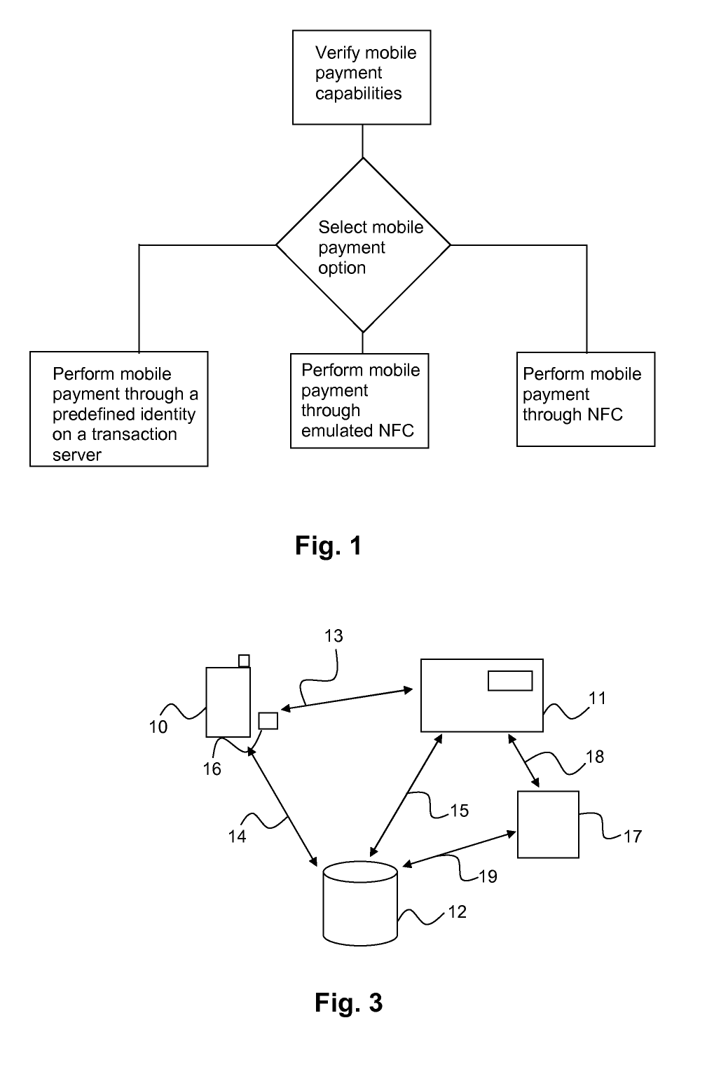

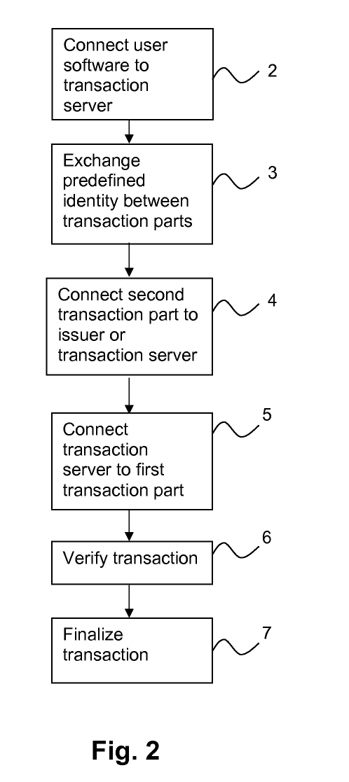

A method for a secure transaction according to an embodiment of the present invention will now be described with reference to FIGS. 1-3.

The method for a secure transaction has a buying part and a selling part, wherein the buying part of the secure transaction utilizes a portable radio communication device, such as a mobile phone, a personal digital assistant, a portable computer or similar device having capability for mobile payments. The selling part usually utilizes a stationary communication device. The transaction is secure by utilization of mobile payment through NFC, through emulated NFC or through a predefined identity on a transaction server, all of which are secure methods of performing mobile transactions.

The method according to this embodiment comprises the steps of:

detecting support for mobile payment through NFC at the buying part of the secure transaction, and

when the selling part of the secure transaction comprises NFC means and the buying part of the secure transaction comprises NFC means the secure transaction is performed by mobile payment through NFC;

when the selling part of the secure transaction comprises NFC means and the buying part of the secure transaction does not comprise NFC means mobile payment through NFC is emulated by the buying part and the secure transaction is performed by mobile payment through NFC with verification of the buying part; and

otherwise the secure transaction between the selling part and the buying part is performed by mobile payment through a predefined identity on a transaction server.

By utilization of this method the most appropriate mobile payment for each possible occasion is utilized. The method is preferably performed by utilization of a software application installed in the portable radio communication device at the buying part and a retail terminal at the selling part.

The method preferably also comprises the step of: when the buying part is detected to not support mobile payment through NFC preparing the buying part for emulation of mobile payment through NFC in parallel to preparing the buying part for mobile payment through a predefined identity on a predefined transaction server.

The method preferably also comprises the step of: when the buying part is detected to support mobile payment through NFC preparing the buying part for mobile payment through NFC in parallel to preparing the buying part for emulation of mobile payment through NFC in parallel to preparing the buying part for mobile payment through a predefined identity on a predefined transaction server

Mobile payment can be made in a plurality of ways and involve a plurality of different payments, with the common feature that a mobile device is involved. Operators and payment industry pursue different projects and developments within this area. The common part for all parties involved is however the use of RFID/NFC in combination with mobile phones. This is connected to the problem regarding upgrade of both buyer and seller equipment. Advantages with connecting NFC to the mobile device and with making mobile payments are e.g. that a higher level of security is achieved, the speed with which a transaction can be performed is improved, the simplicity for both buyer and seller is increased, versatility by utilization of existing devices is improved, flexibility and cost effectiveness is also improved.

NFC is a quick and versatile way of transferring information between two parties without having to make physical contact, but at the same time requiring a close physical proximity. An advantage by using a mobile phone having built-in NFC support is that it is easy to control when the NFC is active and to dynamically change information to send. It further creates possibilities to other areas of use and also reception of data. If NFC is not integrated into the mobile phone the possibility to dynamically change information and to control switching the unit on/off is lost. The present invention solves this problem by combining a secure application and secure methods with a non-integrated NFC module/sticker/tag.

NFC emulation is performed by use of statistical information resembling NFC information in a system which the portable radio communication device connects to, but when verification is required by the issuer of e.g. the credit card the transaction is handled as a NFC emulation transaction and verification is required by the buying part, e.g. passively by the portable radio communication device being switched on or actively by the user entry of a PIN.

The predefined identity is known by both the buying part and the transaction server, such as a social security number, account number, credit card number or similar identity that can be used to find the correct issuer in a distributed multi-nod system. A distributed multi-nod system comprises a plurality of buying parts, a plurality of selling parts, a plurality of predefined transaction servers, and a plurality of issuers and acquires.

In order to preferably secure all links of a transaction, a user transaction software is installed in the portable communication device 10 of the buying part in a secure way, wherein a user is identified in a secure way and tied to the installation. One secure way is to, at e.g. a bank office or other known part, install the user transaction software in the portable radio communication device of the buying part or give a memory card or similar device having an installation program for the buying part thereon. The identity of the owner/user of the portable radio communication device is checked in connection with the installation or delivery of the user transaction software transaction program. Instead of checking the identity directly at a bank office or other known part e.g. a registered letter sent to the intended user can be used to verify the identity of the intended user. Finally the user transaction software is connected to an account at the bank or other part, such as a credit card account, a user account, an electronic wallet, etc. Another secure way to install the user transaction software is to, at e.g. an authenticated Internet bank office or similar part, through a secure connection, e.g. a https connection, install the user transaction software in the portable radio communication device of the buying part. The identity of the owner of the portable radio communication device is checked in connection with the installation through e.g. PIN. Finally the user transaction software is connected to an account at the bank or other part, such as a credit card account, a user account, an electronic wallet, etc.

The user transaction software is arranged to communicate with a predefined transaction server 12 when secure transactions are performed. Information of which account a user transaction software is connected to can be predefined directly at the transaction server or be accessed by the transaction server from the buying part whenever a transaction is to take place. Preferably, a default account is assumed unless another account is given when the buying part is put in an active transaction state on the transaction server. Account balance and similar checks are preferably performed prior to any finalization of a transaction.

When a secure Internet installation is utilized a mobile phone number is preferably given to the distribution site, which in response thereto sends a text message, such as an SMS, with a download URL to that mobile phone number, i.e. a so called over the air installation (OTA installation). By following that link in the mobile phone the user transaction software is installed in the mobile phone. To first start the application run by the user transaction software an activation code, given by the distribution site, is entered. Further, a PIN is also required to be entered to run the application.

When a secure transaction 13 is to take place between the buying part and the selling part, based on the predefined identity on the transaction server, the transaction comprises the following steps. The user of the portable radio communication device, i.e. the buying part, selects a “mobile payment” section of the user transaction software to connect the buying part to the transaction server. The buying part 10 activates itself, through an encoded/encrypted wireless communication, on the transaction server 12, which transaction server 12 thereby puts the buying part 10 in an active transaction state on the transaction server 12.

The buying part 10 preferably stays in the active transaction state on the transaction server 12 until the buying part 10 requests a non-active transaction state. Alternatively, the buying part 10 will be put into a non-active transaction state by the transaction server 12 after a time-out. Further, the transaction server 12 could also put the buying part 10 in a non-active state after finalization of a transaction. By waiting for a request before putting the buying part into a non-active state the advantage is obtained that the user can perform several consecutive transactions without having to reselect the “mobile payment” section of the user transaction software. This is however preferably combined with a time out, which gives the advantage that the user does not forget to put the portable radio communication device in a non-active transaction state, which would be risky if another person gets hold of the portable radio communication device. From a security perspective it would be advantageous to put the buying part in a non-active transaction state also after a transaction has been completed.

The wireless communication can e.g. be performed through GPRS, 3G data, Wi-Fi or WiMAC, all of which could have some kind of built-in identity verification, and even infrared or Bluetooth, which however are anonymous and could require some added identity verification.

To initiate the secure transaction the buying part gives 3 the predefined identity to the selling part 11 through NFC means 16 separate from the portable radio communication device. The selling part 11 assumes this to be a NFC supported transaction and contacts 18 the issuer 17 for e.g. the credit card number.

The issuer of the predefined identity receives information of the secure transaction through NFC means of the selling part and recognizes this secure transaction to be treated as a NFC emulation. The issuer of the predefined identity thus requests 19 verification of the predefined transaction server of the secure transaction. The buying part on the transaction server is identified by the predefined identity and it is checked that the buying part is in the active transaction state on the transaction server. The secure transaction connected to the predefined identity is finalized based on the information of the secure transaction and the predefined identity.

If the selling part does not support NFC the buying part gives the predefined identity to the selling part e.g. orally or by entry into a key set. The selling part 11 activates itself on the transaction server 12, which transaction server 12 thereby puts the selling part 11 in an active transaction state on the transaction server 12. The selling part thereafter sends 4, 15 information of the transaction connected to the predefined identity to the transaction server 12, preferably encrypted. The activation and the following information of the transaction could also be performed in one action, such that the sending of information of the transaction to the transaction server also puts the selling part in an active transaction state on the transaction server. Transaction information from the selling part that is sent with a transaction can vary, but typically includes the name of the selling part and the transaction amount, and possibly also the product name, at a purchase. The name of the selling part could alternatively be extracted from the login of the selling part to the system instead of being sent together with the transaction, to ensure that such information is not distorted. This is usually performed via a landline, but could also be performed via wireless communication. The selling part has previously registered an account at the transaction server, or on another part in a distributed multi-nod system including the transaction server whereby the selling part is known at the transaction server, in a way similarly performed for the buying part. Account information or similar information of the buying part is not necessary to give to the selling part and vice versa, since such information is known by the transaction server, and such information should thus not be given to the selling part and vice versa.

The transaction server 12 identifies the buying part by the predefined identity sent by the selling part and preferably requests 5, through an encoded/encrypted wireless communication, a verification by the buying part of the transaction information connected to the predefined identity. The user transaction software requests 6 e.g. a PIN as verification of the transaction information, such as name of the selling part and transaction amount. The verification is returned, through an encoded/encrypted wireless communication, to the transaction server connected to the predefined identity. An alternative to requesting verification of the buying part, being in active state on the predefined transaction server, is to only check that the portable radio communication device of the buying part is on, which is performed without any active action by the user thereof.

After verification from the buying part the transaction server finalizes 7 the transaction connected to the predefined identity and sends a transaction receipt to both the buying part, through an encoded/encrypted wireless communication, and the selling part, either directly or via the issuer. The transaction is only finalized provided that the accounts of both the buying part and the selling part accept the transaction.

In this case no PIN of other password has been transferred directly between the buying part and the selling part. Further, the PIN has not been transferred between the transaction server and the selling part. The selling part only receives a confirmation that the identification is verified.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1-9. (canceled)

10. A method for secure transaction, wherein a buying part of said secure transaction utilizes a portable radio communication device, comprising the steps of:
detecting support for mobile payment through NFC at said buying part of said secure transaction, and
when a selling part of said secure transaction supports mobile payment through NFC and said buying part of said secure transaction supports mobile payment through NFC said secure transaction is performed by mobile payment through NFC,
when a selling part of said secure transaction supports mobile payment through NFC and said buying part of said secure transaction does not support mobile payment through NFC mobile payment through NFC is emulated by said buying part and said secure transaction is performed by mobile payment through NFC with verification of the buying part; and
otherwise said secure transaction between a selling part and said buying part is performed by mobile payment through a predefined identity on a predefined transaction server.

11. The method according to claim 10, comprising the step of:
when said buying part does not support mobile payment through NFC preparing said buying part of emulation of mobile payment through NFC in parallel to preparing said buying part for mobile payment through a predefined identity on a predefined transaction server.

12. The method according to claim 10, comprising the step of: when said buying part is detected to support mobile payment through NFC preparing said buying part of mobile payment through NFC in parallel to preparing said buying part for emulation of mobile payment through NFC in parallel to preparing said buying part for mobile payment through a predefined identity on a predefined transaction server.

13. The method according to claim 10, wherein said mobile payment through a predefined identity on a transaction server comprises the steps of:
initiating, by wireless encrypted communication, said portable radio communication device on said predefined transaction server, which portable radio communication device thereby is put in an active transaction state as said buying part on said transaction server, wherein a user transaction software in said portable radio communication device has been installed through an authenticated service provider and a user is securely identified and tied to the installation;
initiating, by said predefined identity, said secure transaction between said buying part, utilizing said user transaction software in said portable radio communication device, and said selling part, utilizing a service provider software;
initiating said selling part on said predefined transaction server, which selling part thereby is put in an active transaction state on said transaction server;
sending information of said secure transaction connected to said predefined identity from said selling part to said predefined transaction server;
identifying said buying part and said selling part on said transaction server by said predefined identity and checking that said party and said selling part are in said active transaction state on staid transaction server; and
finalizing said, secure transaction connected to said predefined identity based on said information of said secure transaction and said predefined identity.

14. The method as claimed in claim 13, comprising the steps of:
sending, by wireless encrypted communication, said information of said secure transaction connected to said predefined identity from said predefined transaction server to said buying part;
verifying said secure transaction connected to said predefined identity at said buying part by a user verification; and
sending, by wireless encrypted communication, the verification connected to said predefined identity from said buying part to said transaction server.

15. The method according to claim 14, wherein said verification is performed by entering a personal identification number in said portable radio communication device.

16. The method according to claim 10, wherein the emulation comprises of the steps of:
initiating, by wireless encrypted communication, said portable radio communication device on said predefined transaction server, which portable radio communication device thereby is put in an active transaction state as said buying part on said transaction server, wherein a user transaction software in said portable radio communication device has been installed through an authenticated service provider and a user is securely identified and tied to the installation; and
utilizing NFC means separate from said portable radio communication device, wherein said predefined identity is transferred between said NFC means and said selling part to initiated said secure transaction.

17. The method according to claim 16, comprising the steps of:
an issuer of said predefined identity receives information of said secure transaction to be treated as a NFC emulation;
said issuer of said predefined identity requests verification of said transaction server of said secure transaction;
identifying the buying part on the transaction server by the predefined identity and checking that the buying part is in the active transaction state on the transaction server; and
finalizing the secure transaction connected to the predefined identity based on the information of the secure transaction and the predefined identity.

18. A method for a secure transaction, wherein a selling part of said secure transaction supports mobile payment through NFC and a buying part of said secure transaction utilizes a mobile payment device not supporting mobile payment through NFC, comprising the steps of:
initiating, by wireless encrypted communication, said portable radio communication device on said predefined transaction server, which portable radio communication device thereby is put in an active transaction state as said buying part on said transaction server, wherein a user transaction software in said portable radio communication device has been installed through an authenticated service provider and a user is securely identified and tied to the installation;
utilizing NFC means separate from said portable radio communication device, wherein a predefined identity is transferred between said NFC means and said selling part to initiated said secure transaction;
an issuer of said predefined identity received information of said secure transaction through NFC means of said selling part and recognizes this secure transaction to be treated as a NFC emulation;
said issuer of said predefined identity requests verification of said transaction server of said secure transaction;
identifying the buying part on the transaction server by the predefined identity and checking that the buying part is in the active transaction state on the transaction server; and
finalizing the secure transaction connected to the predefined identity based on the information of the secure transaction and the predefined identity.
